(19) United States
(12) Patent Application Publication
(10) Pub. No.: US 2024/0351005 A1
(43) Pub. Date: Oct. 24, 2024

(54) SILICATE MODIFIED MANGANESE-BASED MATERIAL AND PREPARATION METHOD AND APPLICATION THEREOF

(71) Applicant: Chinese Research Academy of Environmental Sciences, Beijing (CN)

(72) Inventors: Mingxia Zheng, Beijing (CN); Xu Zhang, Beijing (CN); Liu Feng, Beijing (CN); Minda Yu, Beijing (CN); Jing Su, Beijing (CN); Beidou Xi, Beijing (CN)

(21) Appl. No.: 18/503,234

(22) Filed: Nov. 7, 2023

(30) Foreign Application Priority Data
Apr. 23, 2023 (CN) 202310441994.X

(51) Int. Cl. B01J 23/34; B01J 35/00; B01J 37/03; B01J 37/04; C01G 45/12; C02F 1/72

(52) U.S. Cl. CPC B01J 23/34; B01J 35/23; B01J 37/031; B01J 37/04; C01G 45/1214; C02F 1/722; C02F 1/725; C01P 2002/54; C01P 2004/03; C01P 2004/16; C02F 2101/38; C02F 2103/06

(57) ABSTRACT

Provided are a silicate modified manganese-based material and a preparation method and application thereof. The silicate modified manganese-based material has a nanoscale needle like structure, and is prepared from a solution containing a manganese source and a soluble silicate source through an oxidation-reduction reaction and then a hydrothermal reaction. The manganese source includes a divalent manganese source and a heptavalent manganese source, with Mn (II) and Mn (VII) in a molar ratio of 0.5-5.5 to 1. The present disclosure uses silicate to regulate manganese oxides, significantly reducing the particle size of the manganese-based material, generating manganese vacancies, and changing the surface manganese valence state. An advanced oxidation system formed by the silicate modified manganese-based material and an oxidant has high removal rate and reaction rate for various organic compounds.

### CROSS-REFERENCE TO RELATED APPLICATION

The present application claims priority from Chinese Patent Application No. 202310441994.X filed on Apr. 23, 2023, the contents of which are incorporated herein by reference in their entirety.

### TECHNICAL FIELD

The present disclosure relates to the technical field of material preparation, and in particular relates to a silicate modified manganese-based material and a preparation method and application thereof, especially application in the treatment of landfill leachate.

### BACKGROUND

Landfill leachate refers to liquid generated during the stacking and landfill of garbage due to a decomposition effect of the garbage, rainfall, and a seepage effect of external water. Landfill leachate contains various types of inorganic and organic pollutants, including refractory toxic and harmful pollutants. Due to complex composition, leachate cannot be treated well by the conventional biochemical technology, and the leachate not treated well entering the environment will cause deterioration of the water body, soil, and the entire ecosystem. Compared to the conventional water body, the composition of leachate is complex, characterized by high salinity and high organic content, and it is quite difficult to remove the toxic and harmful pollutants from leachate.

In recent years, an advanced oxidation technology based on a manganese oxide and persulfate system has been widely used in water pollution treatment. Manganese oxide has low biological toxicity, is abundant in nature, and is a good green and environmentally friendly material. As the main component of minerals in soil or aquifer materials, manganese dioxide with multivalent properties can directly oxidize pollutants or degrade pollutants based on advanced oxidation with persulfate, etc. However, pure manganese oxide has low adsorption capacity and weak catalytic activity. Currently, modified manganese-based materials are commonly used in advanced oxidation reactions, but most of the existing modified manganese-based materials are modified by heavy metals, which are costly and may cause secondary pollution. Also, the modified manganese-based materials have low removal activity, low reaction rate, and other problems when participating in oxidation and remediation of organic compounds in landfill leachate.

### SUMMARY

### (I) Objective of the Present Disclosure

The objective of the present disclosure is to provide a silicate modified manganese-based material and a preparation method and application thereof. By adjusting the proportion of high valence manganese and low valence manganese in a manganese source and conducting a hydrothermal reaction between the manganese source and the silicate source, a silicate modified manganese-based material with a nanoscale needle like structure is obtained, thereby not only avoiding the problems of high cost and secondary pollution caused by heavy metal modification, but also improving the removal rate and reaction rate of organic compounds using the modified manganese-based material.

### (II) Technical Solution

To solve the above problems, the first aspect of the present disclosure provides a silicate modified manganese-based material with a nanoscale needle like structure, which is prepared from a solution containing a manganese source and a soluble silicate source through an oxidation-reduction reaction and then a hydrothermal reaction. The manganese source includes a divalent manganese source and a heptavalent manganese source, with Mn (II) and Mn (VII) in a molar ratio of 0.5-5.5 to 1.

By controlling the proportion of the high valence manganese source and the low valence manganese source within the range, a silicate modified manganese-based material with an a crystal form is obtained, and the material has a needle like structure, a significantly reduced particle size, and a significantly improved catalytic performance.

In the embodiments of the present disclosure, nanoscale refers to at least one dimension in a three-dimensional space being at a nanoscale (1-100 nM).

Preferably, the ratio of Mn (II) to Mn (VII) is 0.5-2 to 1 to ensure a pollutant removal ratio of 65% or higher.

Preferably, the molar ratio of Si to Mn (VII) in the solution is 0.1-2.8 to 1.

Preferably, the divalent manganese source is selected from at least one of manganese chloride, manganese nitrate, and manganese sulfate.

Preferably, the heptavalent manganese source is selected from at least one of potassium permanganate, sodium permanganate and ammonium permanganate.

Preferably, the soluble silicate source is selected from at least one of sodium silicate, potassium metasilicate, layered crystalline sodium disilicate, layered crystalline potassium disilicate, and multiple layered crystalline composite silicates.

Preferably, the molar ratio of Si to Mn (VII) in the solution is 0.5-2.5 to 1 to ensure a pollutant removal ratio of 65% or higher, and more preferably, the molar ratio of Si to Mn (VII) is 0.5-0.8 to 1 or 1.5-2.5 to 1 to ensure a pollutant removal ratio of 85% or higher.

The silicate manganese ratio may be controlled to further control the particle size of the modified material, ensuring an increased specific surface area of the material and an improved adsorption performance.

Preferably, the solvent of the solution is water.

Preferably, based on the number of moles of silicon atoms, the concentration of the soluble silicate source in the solution is 50-500 mM.

Preferably, the oxidation-reduction reaction is conducted under the following specific conditions of:
stirring at room temperature; and
a reaction time of 0.5-1.5 h.

In this embodiment, the room temperature is at 10-40° C.

Preferably, the hydrothermal reaction is conducted under the following specific conditions of:
a reaction temperature of 140-160° C.; and
a reaction time of 4-12 h.

Preferably, the heating time in the hydrothermal reaction is 25-35 min.

The second aspect of the present disclosure provides a preparation method for any of the aforementioned silicate modified manganese-based materials, including the following steps:
conducting an oxidation-reduction reaction on a solution containing a manganese source and a soluble silicate source to obtain a mixed solution; and
conducting a hydrothermal reaction on the mixed solution to obtain a silicate modified manganese-based material,
the manganese source including a divalent manganese source and a heptavalent manganese source, with Mn (II) and Mn (VII) in a molar ratio of 0.5-5.5 to 1.

The obtained silicate modified manganese-based material has a nanoscale needle like structure.

Preferably, the molar ratio of Si to Mn (VII) in the solution is 0.1-2.8 to 1.

Preferably, the divalent manganese source is selected from at least one of manganese chloride, manganese nitrate, and manganese sulfate.

Preferably, the heptavalent manganese source is selected from at least one of potassium permanganate, sodium permanganate and ammonium permanganate.

Preferably, the soluble silicate source is selected from at least one of sodium silicate, potassium metasilicate, layered crystalline sodium disilicate, layered crystalline potassium disilicate, and multiple layered crystalline composite silicates.

The solvent of the solution is water.

Based on the number of moles of silicate atoms, the concentration of the soluble silicate source in the solution is 50-500 mM.

Preferably, the oxidation-reduction reaction is conducted under the following specific conditions of:
stirring at room temperature; and
a reaction time of 0.5-1.5 h.

Preferably, the hydrothermal reaction is conducted under the following specific conditions of:
a reaction temperature of 140-160° C.; and
a reaction time of 4-12 h.

Preferably, the heating time in the hydrothermal reaction is 25-35 min.

By controlling the proportion of the high valence manganese source and the low valence manganese source within a certain range, and conducting a hydrothermal reaction under such condition, a silicate modified manganese-based material with an a crystal form is obtained, and the material has a significantly reduced particle size and a significantly improved catalytic performance.

Further, the product of the hydrothermal reaction is dried under the following drying conditions of:
a drying temperature of 40-80° C.; and
a drying time of 10-36 h.

The third aspect of the present disclosure provides application of any of the aforementioned silicate modified manganese-based materials and a silicate modified manganese-based material prepared by any of the aforementioned preparation methods in the field of environmental remediation.

Specifically, the field of environmental remediation includes but is not limited to water pollution remediation, and the water pollution remediation includes removal of refractory organic pollutants from natural water bodies (e.g., surface water, and groundwater), wastewater (e.g., industrial production wastewater, and domestic wastewater) and other water bodies. Optionally, the application scenario is a water environment with high salinity (wastewater with a total salt content mass fraction of at least 1%) and high organic pollutants (BOD₅/COD<0.4), e.g., landfill leachate. Preferably, the organic pollutants are refractory organic pollutants that contain strong electron withdrawing groups and are difficult to be attacked by electrophilic reagents, preferably organic pollutants containing nitro and/or chlorine groups, and more preferably parachloronitrobenzene (CNB).

Specifically, in the application, the silicate modified manganese-based material is used together with an oxidant for removing organic pollutants. As shown in FIG. 1, the removal principle is as follows: the silicate modified manganese-based material activates an oxidant to produce active substances to oxidize and mineralize organic pollutants into carbon dioxide and water.

Preferably, the oxidant is peroxymonosulfate and/or persulfate, more preferably peroxymonosulfate.

The surface of the silicate modified manganese-based material provided by the present disclosure contains a large amount of monatomic manganese and defects, which can effectively induce activation of the persulfate, thus overcoming a highly salty and highly organic environment, ensuring that sulfate radicals and hydroxyl radicals generated in an oxidation process can effectively mineralize organic pollutants, and effectively removing high concentration organic pollutants even in a highly salty leachate environment with complex composition.

The silicate modified manganese-based material provided by the present disclosure has a needle like structure, a relatively small particle size, and significantly improved adsorption performance and catalytic oxidation capacity. Moreover, abundant silicate ionsat the material interface can selectively adsorb refractory organic pollutants containing strong electron withdrawing groups, further ensuring the effect of removing such organic pollutants from landfill leachate.

Preferably, the dosage of the silicate modified manganese-based material is 0.2-2 g/L.

Preferably, the dosage of the oxidant is 1-20 mmol/L.

Preferably, the silicate modified manganese-based material is used together with an oxidant for removing organic pollutants under the following specific conditions of:
a pH value of 3-9 in a reaction system;
room temperature; and
a reaction time of 50-80 min.

In a specific application scenario, the silicate modified manganese-based material is used for remediating organic pollutants from landfill leachate at:
a pH value of 3-9 in a reaction system,
room temperature; and
a reaction time of 50-80 min.

The dosage of the silicate modified manganese-based material is 0.2-2 g/L.

The oxidant is peroxymonosulfate and/or persulfate, preferably peroxymonosulfate, and the silicate modified manganese-based material is used for activating the oxidant.

Based on the number of moles of the oxidant, the dosage of the oxidant is 1-20 mmol/L.

In this application scenario, multiple water quality purification mechanisms such as coupling adsorption and flocculation may be further combined, so that the effluent is stable, the operation is easy, the problems of high cost, complex operation and maintenance, unstable biochemical treatment, and the like of a conventional advanced oxidation technology are solved, and efficient and advanced treatment of leachate is achieved.

### (III) Beneficial Effects

The above technical solution of the present disclosure has the following beneficial technical effects:

The preparation method of the silicate modified manganese-based material provided by the present disclosure uses silicate to regulate manganese oxides, significantly reducing the particle size of the manganese-based material, generating manganese vacancies, and changing the surface manganese valence state. An advanced oxidation system formed by the silicate modified manganese-based material and the oxidant has high removal rate and reaction rate for various organic compounds.

The silicate source used in the present disclosure is green, non-toxic, and cost-effective, thus avoiding the problem of secondary pollution in the remediation process.

The preparation method provided by the present disclosure has simple process and convenient operation, and can achieve large-scale production and preparation.

### BRIEF DESCRIPTION OF THE DRAWINGS

FIG. 1 is a diagram of reaction mechanism of a manganese-based material activating an oxidant.

FIG. 2 is an SEM image of the silicate modified manganese-based material provided in an embodiment of the present disclosure, where a shows an unmodified manganese-based material and b shows the modified manganese-based material.

FIG. 3 is a diagram of the effects in removing CNB using silicate modified manganese-based materials provided in Example 1 and Comparative Example 2 of the present disclosure for activating an oxidant.

FIG. 4 is a diagram of the effects in removing CNB using silicate modified manganese-based material provided in Example 1 and a manganese-based material provided in Comparative Example 1 of the present disclosure for activating an oxidant.

FIG. 5 is a diagram of the effects in removing CNB using silicate modified manganese-based materials provided in Examples 1-3 and a manganese-based material provided in Comparative Example 2 of the present disclosure for activating an oxidant and reacting for 60 min.

FIG. 6 is a diagram shows the effectiveness of using the silicon-modified manganese-based material provided in Example 1-3 of the present disclosure and the comparative example 2 for activating PMS to remove Cu-EDTA, as well as the individual effect of the silicon-modified manganese-based material and PMS on Cu-EDTA removal.

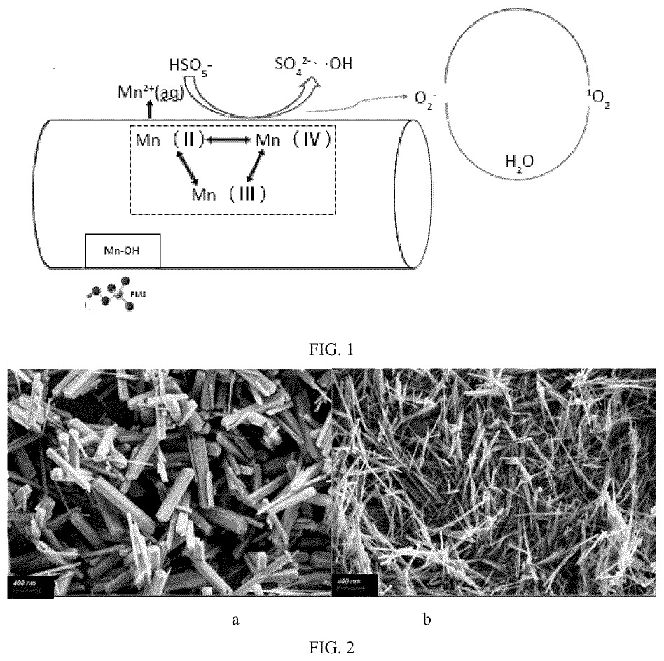

### DETAILED DESCRIPTION

To make the objective, technical solution, and advantages of the present disclosure clearer, the following is a further detailed explanation of the present disclosure in conjunction with specific embodiments and with reference to the accompanying drawings. It is to be understood that these descriptions are only illustrative and not intended to limit the scope of the present disclosure. In addition, in the following explanation, well-known structures and technologies are not described to avoid unnecessary confusion with the concepts of the present disclosure.

The raw materials and reagents used in the embodiments of the present disclosure are conventional commercially available products.

### Example 1

0.1214 g of layered crystalline sodium disilicate was added to 117 mL of water and stirred evenly to obtain a mixed solution I.

17.78 mL of a KMnO₄ aqueous solution (0.15 mol/L) and 4.45 mL of an MnSO₄ aqueous solution (0.9 mol/L) were added to the mixed solution I to obtain a mixed solution II.

After being magnetically stirred for 30 min, the mixed solution II was transferred to a muffle furnace and heated at 160° C. for 4 h to conduct a hydrothermal reaction. After the hydrothermal reaction is completed, a reactor was taken out and naturally cooled to room temperature. The obtained powder was washed with deionized water and anhydrous ethanol many times and dried in a heat treatment furnace at 60° C. to obtain a silicon modified manganese-based material.

### Examples 2-3

Examples 2-3 respectively provide a silicate modified manganese-based material, and a preparation method thereof is basically the same as that of Example 1, with the differences shown in Table 1.

TABLE 1
Preparation conditions of Examples 1-3 and Comparative Examples 1 and 2

| | Example | Example | Example | Comparative | Comparative |
|---|---|---|---|---|---|
| Example | 1 | 2 | 3 | Example 1 | Example 2 |
| Molar ratio of Mn | 3:2 | 3:2 | 3:2 | 6:1 | 3:2 |
| (II) to Mn (VII) | | | | | |
| Molar ratio of | 0.5 | 1 | 2 | 0.5 | 0 |
| Si to Mn (VII) | | | | | |
| Hydrothermal | 160° C., | 160° C., | 160° C., | 160° C., | 160° C., |
| reaction conditions | 4 h | 4 h | 4 h | 4 h | 4 h |

Characterization of silicate modified manganese-based materials provided in the Examples:

The present disclosure takes the silicate modified manganese-based material provided in Example 1 as a typical representative for characterization, and the silicate modified manganese-based materials provided in other Examples all have the same or similar characteristics.

### 1. SEM Analysis

From FIG. 2, the silicate modified manganese-based material provided in an example of the present disclosure has better dispersion and more uniform morphology compared to an unmodified material, and presents a needle like structure.

### 2. Energy Spectrum Analysis

TABLE 1
Energy spectrum of unmodified manganese-based
material provided in Comparative Example 2

| Distribution map | | | | |
|---|---|---|---|---|
| total spectrum | | Percentage | Wt % | Atomic |
| Element | Line type | by weight | Sigma | percentage |
| Si | K series | 0.38 | 0.06 | 0.73 |
| Mn | K series | 99.17 | 0.09 | 98.63 |
| K | K series | 0.46 | 0.06 | 0.64 |
| Total | | 100.00 | | 100.00 |

TABLE 2
Energy spectrum of silicate modified manganese-
based material provided in Example 1

| Distribution map | | | | |
|---|---|---|---|---|
| total spectrum | | Percentage | Wt % | Atomic |
| Element | Line type | by weight | Sigma | percentage |
| Si | K series | 1.60 | 0.15 | 3.01 |
| Mn | K series | 92.15 | 0.22 | 88.55 |
| K | K series | 6.25 | 0.17 | 8.44 |
| Total | | 100.00 | | 100.00 |

From Tables 1 and 2, the silicon content in the material is significantly increased, and a silicate modified manganese-based material is obtained.

### 3. Test on the Activation and Oxidation Performance of the Silicate Modified Manganese-Based Materials Provided in the Examples and the Materials Provided in the Comparative Examples:

### The Specific Testing Method Includes:

### CNB Removal Effect Test:

An oxidant and a catalyst were added to 100 mL of a CNB solution with a concentration of 5 mg/L as a simulated polluted water body. The oxidant was potassium persulfate with a dosage of 6 mM, and the catalyst was the silicate modified manganese-based materials provided in the examples or the manganese-based materials provided in the comparative examples with a dosage of 0.4 g/L. The reaction was conducted at room temperature on a magnetic stirrer, and samples were taken periodically to determine the CNB content by high-performance liquid chromatography.

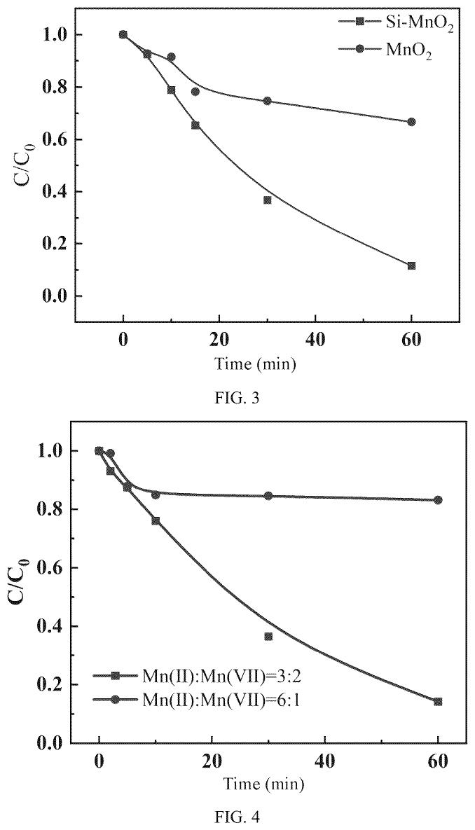

The results are shown in FIGS. 3, 4 and 5. After 60 min of reaction, the CNB removal rate in a PMS system containing the silicate modified manganese-based materials provided in the Examples all reached 65% or higher, with a maximum of 90% or higher, while the highest CNB removal rate in a PMS system containing the manganese-based materials provided in the comparative examples is only about 35%.

### Cu-EDTA Removal Effect Test.

All degradation experiments were conducted in 150 ml conical flasks, where the composition and proportions of the reaction system were adjusted according to the experimental conditions. The commonly used reaction conditions are as follows: 1 mM of PMS (potassium persulfate) was added to a 100 mL solution containing 12.8 mg/L Cu-EDTA, followed by the addition of 0.4 g/L silicon-modified manganese material to initiate the reaction. The entire reaction was carried out at a constant temperature of 25° C. on a magnetic stirrer with uniform stirring. At 0, 5, 10, 20, 30, and 50 minutes, 1 mL of the reaction mixture was taken and mixed with 0.1 mL of ethanol, followed by filtration through a 0.22 μm PTFE (polytetrafluoroethylene) filter. The obtained samples were subsequently analyzed for Cu-EDTA using high-performance liquid chromatography.

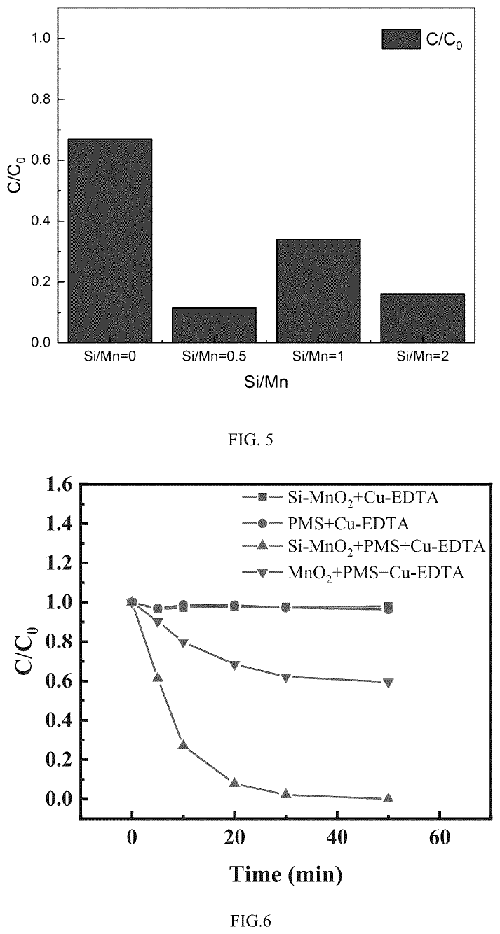

The results of Cu-EDTA removal using Si—MnO₂ and MnO₂ as catalysts with PMS are shown in FIG. 6. In the activation of PMS experiment, Si—MnO₂ completely removed Cu-EDTA within 50 minutes, while MnO₂ only achieved a removal rate of 40.5% within the same time frame. To eliminate the influence of PMS decomposition and the self-oxidation of Si—MnO₂ on Cu-EDTA removal, two control groups were set up. The individual removal rates of Cu-EDTA by PMS and Si—MnO₂ catalyst alone were 3.7% and 2% respectively, indicating that the effective activation of PMS by Si—MnO₂ catalyst is the main reason for Cu-EDTA removal.

It is to be understood that the above specific embodiments of the present disclosure are only for illustrative purposes or to explain the principles of the present disclosure, and do not constitute limitations to the present disclosure. Therefore, any modifications, equivalent substitutions, improvements, etc. made without departing from the spirit and scope of the present disclosure shall be included in the scope of protection of the present disclosure. In addition, the appended claims of the present disclosure aim to cover all changes and modifications falling within the scope and boundaries of the appended claims, or equivalent forms of such scope and boundaries.

What is claimed is:

1. A silicate modified manganese-based material, having a nanoscale needle like structure, and being prepared from a solution containing a manganese source and a soluble silicate source through an oxidation-reduction reaction and then a hydrothermal reaction, the manganese source comprising a divalent manganese source and a heptavalent manganese source, with Mn (II) and Mn (VII) in a molar ratio of 0.5-5.5 to 1.

2. The silicate modified manganese-based material according to claim 1, wherein the molar ratio of Si to Mn (VII) in the solution is 0.1-2.8 to 1.

3. A preparation method of the silicate modified manganese-based material according to claim 1, comprising the following steps:
conducting an oxidation-reduction reaction on a solution containing a manganese source and a soluble silicate source to obtain a mixed solution; and
conducting a hydrothermal reaction on the mixed solution to obtain a silicate modified manganese-based material,
the manganese source comprising a divalent manganese source and a heptavalent manganese source, with Mn (II) and Mn (VII) in a molar ratio of 0.5-5.5 to 1.

4. The preparation method according to claim 3, wherein
the divalent manganese source is selected from at least one of manganese chloride, manganese nitrate, and manganese sulfate;
the heptavalent manganese source is selected from at least one of potassium permanganate, sodium permanganate and ammonium permanganate; and
the soluble silicate source is selected from at least one of sodium silicate, potassium metasilicate, layered crystalline sodium disilicate, layered crystalline potassium disilicate, and multiple layered crystalline composite silicates.

5. The preparation method according to claim 3, wherein the oxidation-reduction reaction is conducted under the following specific conditions of:
stirring at room temperature; and
a reaction time of 0.5-1.5 h.

6. The preparation method according to claim 3, wherein the hydrothermal reaction is conducted under the following specific conditions of:
a reaction temperature of 140-160° C.; and
a reaction time of 4-12 h.

7. A method for removing organic pollutants from a contaminated water body, the method comprising adding the silicate modified manganese-based material according to claim 1 and an oxidant for removing organic pollutants into the contaminated water body;
wherein the oxidant is peroxymonosulfate and/or persulfate.

8. The method according to claim 7, wherein
the dosage of the silicate modified manganese-based material is 0.2-2 g/L; and
the dosage of the oxidant is 1-20 mmol/L.

9. The method according to claim 8, wherein the silicate modified manganese-based material and the oxidant are reacted in the water body under the following specific conditions:
a pH value of 3-9;
room temperature; and
a reaction time of 50-80 min.
